(19) United States
(12) Patent Application Publication
(10) Pub. No.: US 2015/0356508 A1
(43) Pub. Date: Dec. 10, 2015

(54) COLLABORATION USING EXTENSIBLE STATE SHARING

(71) Applicant: International Business Machines Corporation, Armonk, NY (US)

(72) Inventors: Parag S. Gokhale, Pune (IN); Nilesh M. Joshi, Pune (IN); Amit Mittal, Pune (IN)

(21) Appl. No.: 14/298,326

(22) Filed: Jun. 6, 2014

(51) Int. Cl. G06Q 10/10; H04L 29/06; H04L 29/08

(52) U.S. Cl. CPC G06Q 10/103; H04L 67/10; H04L 65/403

(57) ABSTRACT

Collaboration using extensible state sharing, each state including information dimensions, a subsequent state based on one or more previous states and being associated to the one or more previous states by a path. Receiving, by a computer, a state and determining, by the computer, if a stored state is within a proximity threshold of the received state based on the information dimensions of the stored and received states. Responsive to determining a stored state is within a proximity threshold of the received state, merging, by the computer, the stored state and the received state.

### BACKGROUND

The present disclosure relates generally to computer conferencing and more particularly to enabling collaborative analysis using extensible state sharing.

Analytics, the systematic computational analysis of data or statistics, is often practiced with iterative, methodical exploration of data. Businesses may apply analytics to business data to describe, predict, and improve business performance. Business analytics may answer questions like why is this happening? what if these trends continue? what will happen next (predict)? and what is the best that can happen (optimize)?

Businesses may also encourage collaborative techniques and incorporate business applications that enable employees to collaborate and share information in order to foster innovation and solve business problems more efficiently. Collaborative analytics is the combination of analytical tools with collaborative techniques to leverage social functionality to improve business decision-making.

### SUMMARY

Embodiments of the present invention disclose a method, computer program product, and system for collaboration using extensible state sharing, each state including information dimensions, a subsequent state based on one or more previous states and being associated to the one or more previous states by a path. Receiving, by a computer, a state and determining, by the computer, if a stored state is within a proximity threshold of the received state based on the information dimensions of the stored and received states. Responsive to determining a stored state is within a proximity threshold of the received state, merging, by the computer, the stored state and the received state.

In another aspect, wherein each state is associated with a collaboration community, one or more subscribers are associated with each collaboration community, and the information dimensions of each state includes a collaboration community identifier. Responsive to determining a stored state is within a proximity threshold of the received state, determining, by the computer, if the collaboration community identifier associated with the stored state is equal to the collaboration community identifier associated with the received state. Responsive to determining the collaboration community identifier associated with the stored state is equal to the collaboration community identifier associated with the received state, merging, by the computer, the stored state and the received state and transmitting to the subscriber, by the computer, the merged state. Responsive to determining the collaboration community identifier associated with the stored state is not equal to the collaboration community identifier associated with the received state, transmitting to the subscriber, by the computer, an indicator that the stored state is within the proximity threshold of the received state.

### BRIEF DESCRIPTION OF THE SEVERAL VIEWS OF THE DRAWINGS

Features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts states and paths in an exemplary collaboration community, in accordance with an embodiment of the disclosure;

FIG. 2 illustrates a functional block diagram of an exemplary extensible state sharing environment, in accordance with an embodiment of the disclosure;

FIG. 3 depicts merged states in an exemplary collaboration community, in accordance with an embodiment of the disclosure;

FIG. 4 is a flowchart illustrating the operation of collaboration manager, in accordance with an embodiment of the disclosure;

FIG. 5 depicts a block diagram of components of the computing device and member devices of an extensible state sharing environment, in accordance with an embodiment of the disclosure.

### DETAILED DESCRIPTION

Collaboration encourages people to apply their unique talents to group projects. A collaborative group of individuals, or collaboration community, may apply their talents to group projects or may contribute their insights to other collaborators' individual projects. Collaboration may occur in real-time, allowing multiple collaborators to work together on a project simultaneously, or may occur off-line, allowing collaborators to work on a project even when there may be no access to a network connection or other collaborators.

The most common real-time collaboration community may be co-workers in the same room using tools such as white boards, markers, internet enabled laptops, etc. to solve a problem. This real-time collaboration may become less efficient when remote collaborators are part of the collaboration community. Remote collaborators may not have the same collaboration tools available to them, and remote collaborators may not always be able to participate in real-time, for example, due to time zone differences. Collaborative problem solution insights made during the real-time collaboration may be missed by remote collaborators, along with the opportunity to contribute insights.

Another example of real-time collaboration, collaborative editing, may allow multiple collaborators in remote locations and time zones to simultaneously edit a computer file using different computers. This type of collaboration may enable remote collaboration, but the collaboration may need to be closely coordinated such that each collaborator works on a distinct segment of code since the work of one collaborator may overwrite the work of other collaborators. This type of real-time collaboration may not preserve the work of individual collaborators nor preserve interim versions of the edited file; as each collaborator modifies the file, earlier edits may be lost. Preserving work of individual collaborators and preserving interim versions of work in locally accessible storage may allow for both real-time and off-line collaboration.

Since analytics may be an iterative exploration of data, with new exploration based on a previous exploration, various embodiments of the disclosure may create a “state” during each iteration of data exploration. A state may include, for example, information dimensions associated with a query, such as problem description, data returned by the query request, the source of the data (such as dataset name) or uniform resource locator (URL) queried, tags or annotations provided by the collaborator during analysis, information relating to the collaborator making the request (such as area of expertise), and information associating the state with a collaboration community (such as a collaboration community identifier.)

States may be preserved, for example, by storing the state information in a file, and assigning a URL to each created state, as well as to a sequence of created states, or paths. The states may be stored persistently, for example, in a database that is accessible via the Internet and/or an intranet. The state and path URLs may be bookmarked in a web browser, pasted into a document or email, or otherwise stored or shared. Preserved states and paths may be viewed, managed, regenerated, built upon, and shared. Collaborators sharing states may view, regenerate, and build upon the shared states either in real-time or off-line. Collaborators sharing states may work together in a group on a common copy of the states and paths or may work in isolation on a copy of the states and paths maintained in local storage. In various embodiments, states may be shared irrespective of the time of day or geographic location. In certain embodiments, shared states may be received, while states are simultaneously being built upon and shared, and all the while each collaborator's states and paths may be preserved.

Building upon a state for the next iteration of data exploration may extend the state. States may, therefore, be considered extensible. Since analytical, iterative exploration of data does not always proceed in a straight path where each data exploration iteration builds on all the preceding states, explorations of data iterations may build upon any previous state. Sharing states and paths among collaborators provides the ability to share not only the final results of analysis, but also the entire analytical journey, thus providing the flexibility for collaborators to build on any previous state.

Various embodiments may establish a collaboration community of members, either working together on a solution to a common problem or working individually on solutions to similar problems. Various embodiments may automatically share states among members of a collaboration community as well as identify states outside the collaboration community, where collaboration may be advantageous.

Exemplary embodiments of the disclosure are described using analytics, states, and paths created during iterative exploration of data for extensible state sharing. Those of skill in the art will appreciate that other embodiments of the invention may be used to advantage for numerous other extensible states such as versions of program instructions (states) that allow users to extend programs by inserting their own program routines, defining new data types, or defining new formatting markup tags.

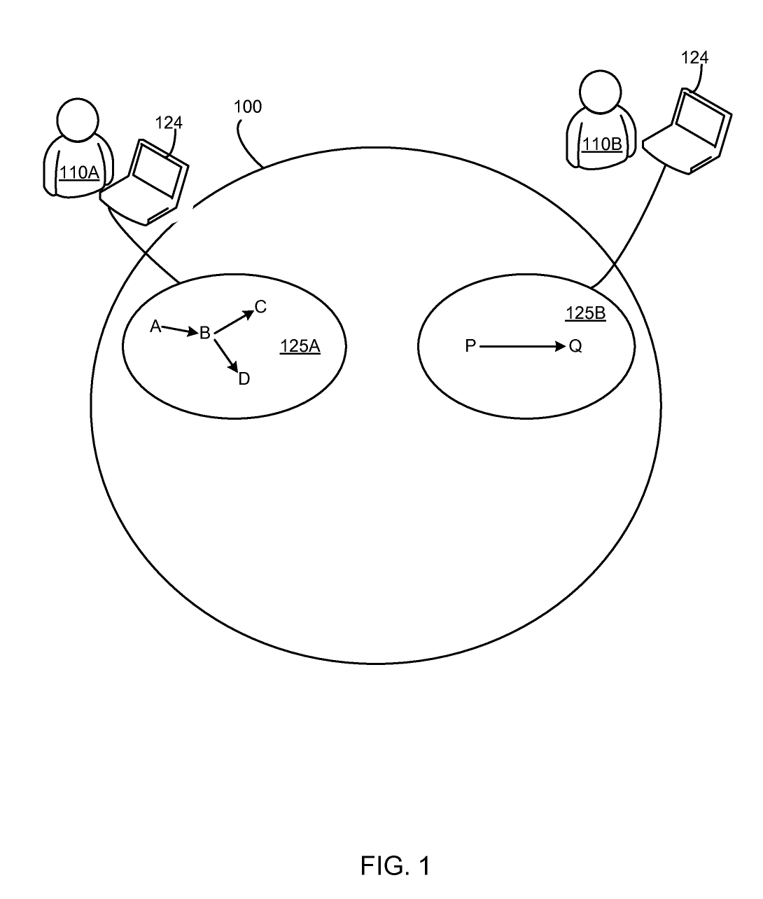

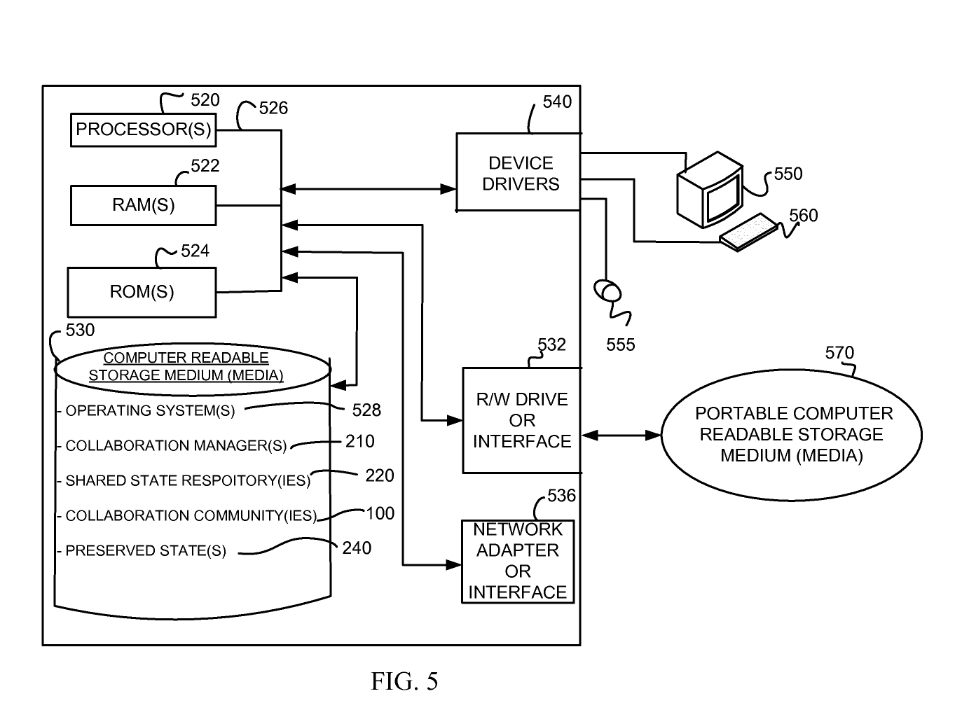

FIG. 1 depicts states and paths in an exemplary collaboration community 100, in accordance with an embodiment of the disclosure. The exemplary collaboration community 100 includes exemplary shared states A, B, C, D, P, Q, and exemplary shared paths 125A, 125B created by members 110A and 110B who may be working together in real-time or separately, in isolation, to solve a business problem. Collaboration community members 110 may preserve the shared states A, B, C, D, P, Q, and paths 125 in a database that is accessible to all members 110 via the Internet and/or an intranet and in a central storage, for example, a computer readable storage media 530 (FIG. 5) or a portable computer readable storage medium (media) 570 (FIG. 5) shared by members 110. Copies of the states and paths may be maintained locally by each member 110, such as on a hard drive of a device 124. Maintaining local copies of states and paths may allow a member 110A, 110B to work off-line. Upon reconnecting to the Internet, intranet, shared central storage, etc., a device 124 may share newly created states with the collaboration community 100 and may receive any states shared by other members 110 of the collaboration community 100 while the device 124 was off-line.

Exemplary states A, B, C, D and exemplary path 125A are depicted as created by member 110A, while exemplary states P, Q and exemplary path 125B are depicted as created by member 110B during analytic iterations of data exploration. With regard to path 125A, state A depicts the state created for the initial iteration of data exploration for member 110A. State B depicts the state created as the result of an iteration built upon state A. States C and D depict states created as a result of separate and distinct iterations built upon state B.

Since each state may be distinct and since new states may be added by an iteration of data exploration, work done off-line and work done on-line, simultaneously by multiple members 110, may not overwrite or conflict with the work of another member 110.

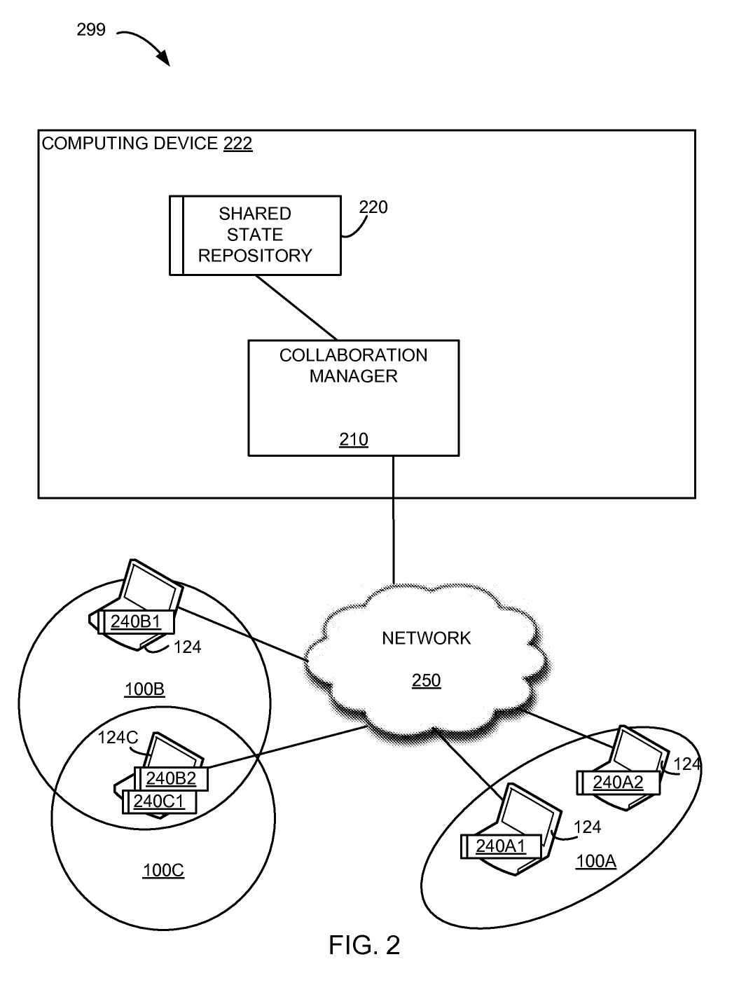

FIG. 2 illustrates a functional block diagram of an exemplary extensible state sharing environment 299, in accordance with an embodiment of the disclosure. Extensible state sharing environment 299 may include a plurality of collaboration communities 100A, 100B, 100C, and a computing device 222 which manages collaboration.

Computing device 222 may include a collaboration manager 210 and one or more repositories 220 of shared states and paths, all of which may be stored, for example, on a computer readable storage medium, such as computer readable storage medium (media) 530 (FIG. 5) or portable computer readable storage medium (media) 570 (FIG. 5).

In various embodiments, collaboration communities 100A, 100B, 110C may include a plurality of members 110 working on a plurality of devices 124, such as personal computers, capable of connecting to computing device 222 through a network 250. In various embodiments, a device 124 may transmit information, when connecting to collaboration manager 210, that identifies the member 110 utilizing the device 124. In various embodiments, devices 124 may maintain local copies of states and paths 240A1, 240A2, 240B1, 240B2, 240C1 allowing members 110 to work off-line, programs that preserve states and paths, programs that share states with collaboration manager 210, programs that receive shared states from collaboration manager 210, programs that manage the received states, and programs that handle communications with collaboration manager 210. Devices 124 may be configured to receive states, automatically, in real-time or to receive states manually at any time. Any states shared while a device 124 is off-line, or disconnected from collaboration manager 210, may be managed by device 124 to be automatically received when the device 124 reconnects with collaboration manager 210. The choice of automatic or manual receipt of shared states may be user controlled. In certain embodiments, the computing devices 124 may be computing device 222.

The network 250 may include the Internet, a local area network or other, wide area network or wireless network. The network 250 may be implemented with any architecture designed for passing data and/or control information between processors (such as microprocessors, communications and network processors, etc.), system memory, peripheral devices, and any other hardware components within a system and may comprise copper wires, optical fibers, wireless transmission, routers, firewalls, switches, gateway computers, and/or edge servers, in accordance with an embodiment of the disclosure.

Collaboration communities 100 may overlap, as depicted with collaboration communities 100B and 100C, where one or more members 110 may collaborate in more than one collaboration community 100. An exemplary computing device 124C may maintain and manage copies of states and paths 240B2, 240C1 for collaboration communities 100B and 100C. The copy of states and paths 240B2 may include the states and paths shared with collaboration community 100B, while the copy of states and paths 240C1 may include the states and paths shared with collaboration community 100C.

In various embodiments, collaboration manager 210 may receive a state to be shared from any connected device 124, maintain a repository of shared state information 220, hereinafter “repository”, transmit shared state information, and identify other shared states in the repository 220 with potential collaboration possibilities due to their similarity to the received shared state. Collaboration manager 210 may also identify potential new collaborators based on the identified possibilities. In various embodiments, collaboration manager may maintain a repository 220 for each collaboration community 100. In other embodiments, collaboration manager 210 may maintain a single repository 220 for a plurality of collaboration communities 100.

In various embodiments, collaboration manager 210 may create a collaboration community 100 for a received state that is not already associated with a collaboration community 100 when the state is added to the repository 220. The created collaboration community 100 may initially include only the member 110 sharing the state. In certain embodiments, a collaboration community 100 may be manually created by individuals working together on a problem. In a manually created collaboration community 100, the owning member 110 of the collaboration community 100 may choose to add other members 110, to collaborate, based on the commonality of the problems they are all trying to solve.

In various embodiments, collaboration manager 210, may manage the repository 220 with publish, subscribe protocols. Collaboration community members 110 may publish, or share, a state by transmitting the state from their device 124, to be received by collaboration manager 210 on computing device 222. Collaborators may register with collaboration manager 210 to subscribe to the shared states of one or more collaboration communities 100. Collaboration manager 210 may transmit the published states, along with the state's path information to all subscribers. In various embodiments, subscribers must be members 110 of the collaboration community 100 to which they subscribe. In certain embodiments, a subscriber may be permitted to subscribe to the shared states of a collaboration community 100 to which they are not a member 110. In various embodiments, all members 110 of a collaboration community 100 are automatic subscribers of shared states in their collaboration community 100.

In certain embodiments, collaboration manager 210 may include control information in repository 220 that define the collaboration capabilities of members 110, such as the ability to contribute created states. In various embodiments, some members 110 of a collaboration community 100 may be able to share states, invite new members 110 to the collaboration community 100, and permit non-members to subscribe to the shared states of the collaboration community 100, while other members 110 may be limited to subscribing to shared states.

In certain embodiments, collaboration manager 210 may maintain the repository 220 as a transaction log. In various embodiments, the repository 220 may include reference information that uniquely identifies the shared state including, but not limited to, the collaboration community 100 sharing the state, the member 110 sharing the state (or sender), the state identifier, the parent state (state upon which the shared state is built) identifier, paths connecting this state to other states, the member 110 originating the path, and the state dimensions. Certain embodiments may also include the data that resulted from the exploration of data. The repository 220 may also include control information that collaboration manager 210 may utilize to identify members 110 of a collaboration community 100, to define each member's 110 collaboration capabilities, and to register subscribers.

In various embodiments, collaboration manager 210 may look for collaboration possibilities as each shared state is received. Collaboration manager 210 may look for collaboration possibilities by analyzing the received state's dimensions and identifying other shared states, stored in repository 220, with similar dimensions. In various embodiments, collaboration manager 210 may utilize a proximity algorithm, such as a “Nearest Neighbor” search, to analyze and identify good candidate states for collaboration with the received state. In various embodiments, collaboration manager 210 may use, for example, locality sensitive hashing techniques (LSH) to identify a nearest neighbor state. LSH techniques may group the content of each dimension of the received state and the content of each dimension of the other states in the repository 220 based on a metric operating on the dimension's content. Dimension content that may be deemed similar, under the chosen metric, may be grouped into the same “bucket.” A bucket may be implemented as, but is not limited to, an array element and a hash table entry. The more buckets a particular state shares with the received state, the more similar the two states may be. In certain embodiments, a proximity threshold value may be set. An exemplary proximity threshold may be a minimum number of buckets that the received state and another state or states from the repository 220 have in common. States meeting or exceeding the threshold may be considered good candidates for collaboration, while those with fewer buckets in common may not be considered good candidates for collaboration. In various embodiments, some dimensions may be weighted more heavily, for example may count as two buckets when determining proximity, in order to prioritize states matched in those dimensions. The identified states may originate from any collaboration community 100 utilizing collaboration manager 210.

Identifying good candidates for collaboration from a different collaboration community 100 may, in certain embodiments, allow collaboration manager 210 to encourage expanded collaboration by automatically initiating collaboration communications with the owners of the identified proximity matched states from the repository 220 and with the owner of the received shared state. Certain embodiments may initiate collaboration communication with all collaborating members 110 in the received state's collaboration community 100.

In certain embodiments, collaboration manager 210 may communicate, using a signal or an alert, to notify members 110, in the collaboration community 100 of the received shared state, that a potential new collaborator has been identified. In various embodiments, collaboration manager 210 may only act upon a response from the owner of the received shared state to determine whether the potential new collaborator is to be invited to join the collaboration community 100. In other embodiments, a response to “invite” the potential collaborator to join the collaboration community 100 may come from any member 110 in the collaboration community 100 enabled to invite new collaborators. In other embodiments, a unanimous response from all enabled members 110 to “invite” may be needed for collaboration manager 210 to initiate an “invitation” signal to the potential collaborator from another collaboration community 100.

For a collaborator from another collaboration community 100 that is to be invited into the received state's collaboration community 100, collaboration manager 210 may initiate a “join invitation” to the potential new collaborator. In certain embodiments, the potential collaborator's capabilities in the received state's collaboration community 100 may be defined in the responses from the members 110 of the received state's collaboration community 100. In other embodiments, the invited collaborator's capabilities may be defined when the collaboration community 100 is established. In various embodiments, collaboration manager 210 may remove a “joining” collaborator from their prior collaboration community 100, add them to the new collaboration community 100, and update the collaboration community 100 information, maintained in repository 220, such that the identified proximity matched states are added to the received state's collaboration community 100.

In certain embodiments, collaboration manager 210 may time-out waiting for a response. If collaboration manager times-out or receives a response to “not-invite” from any collaboration enabled member 110, collaboration manager 210 may ignore future proximity matches between the identified state and the collaboration community 100.

An identified proximity matched state may be associated with the same collaboration community 100 as the received state. The states may have been created in the same collaboration community 100 or may be in the same collaboration community 100 as a result of collaboration manager 210 joining the identified proximity matched state from another collaboration community 100 with the received state's collaboration community 100. In various embodiments, collaboration manager 210 may merge both states' paths by adding the repository 220 path information of the received state to the repository 220 path information of the identified proximity matched state and adding the repository 220 path information of the proximity matched state to the repository 220 path information of the received state, and transmit the merged information to all subscribers.

In various embodiments, a received state and a proximity matched state may be determined to be duplicates. In certain embodiments, duplicates may be stored in repository 220 as a single state, since duplicates may not aid in analysis. In various embodiments, duplicates may be an exact match between the received state and the proximity matched state. In other embodiments, a similarity threshold may be configured, above which the states may be considered duplicates.

In various embodiments, collaboration manager 210 may include default proximity match algorithms and default values for proximity thresholds. In other embodiments, the proximity match algorithms and proximity threshold values may be configurable. In certain embodiments, the proximity match algorithms and proximity threshold values utilized may be defined by the member 110 creating the state or the owning member 110 of the collaboration community 100 and may be included in the received state's dimensions.

Computing device 222 and devices 124 represent computing devices, systems or environments, and may be laptop computers, notebook computers, personal computers (PC), desktop computers, tablet computers, thin clients, mobile phones or any other electronic devices or computing systems capable of performing the required functionality of embodiments of the disclosure. Computing devices 222, 124 may include internal and external hardware components, as depicted and described in further detail with respect to FIG. 5. In other various embodiments of the present disclosure, computing devices 222, 124 may represent a computing system utilizing clustered computers and components to act as a single pool of seamless resources. In general, computing devices 222, 124 are representative of any programmable electronic devices or combination of programmable electronic devices capable of executing machine-readable program instructions in accordance with an embodiment of the disclosure.

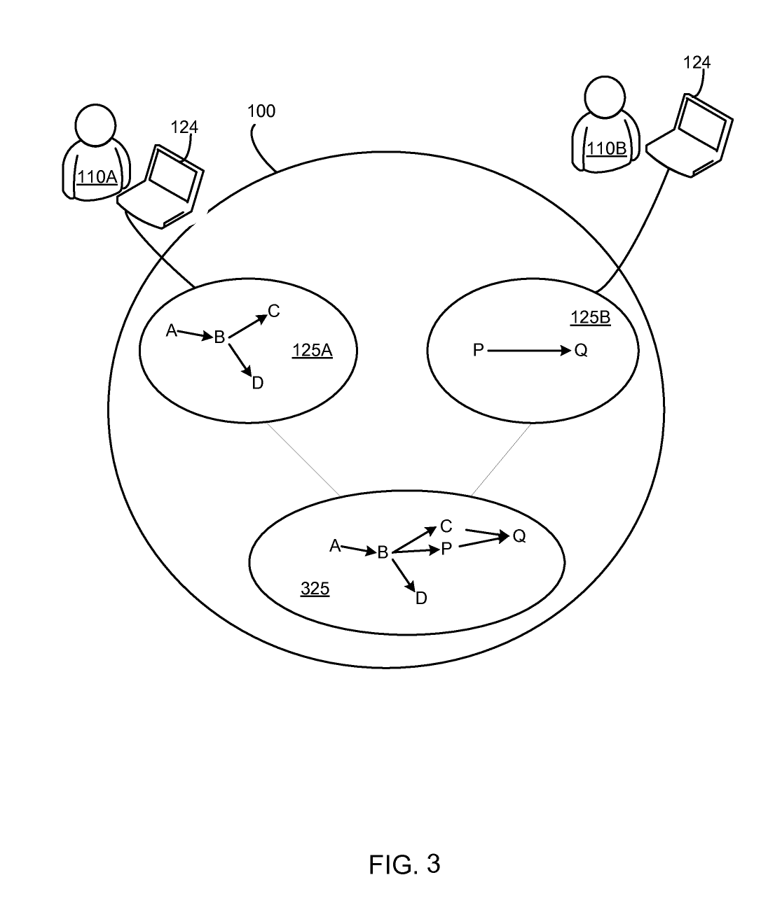

FIG. 3 depicts merged states' paths in the exemplary collaboration community 100, in accordance with an embodiment of the disclosure. The exemplary states A, B, C, D, P, Q and exemplary paths 125A, 125 B of FIG. 1 are depicted in a single collaboration community 100. In an exemplary sharing of state C, collaboration manager 210 may have identified state P, already in repository 220, as a proximity match for the received state C. Since states C and P are in the same collaboration community 100, collaboration manager 210 may merge the states C and P in repository 220. The repository 220 path information for state C may be added to the repository 220 path information for state P; and the repository 220 path information for state P may be added to the repository 220 path information for state C. The resulting merged path 325 allows each member 110 to follow the analytic journey of other members 110, determined by collaboration manager 210 to be doing similar analysis, while preserving each member's 110 individual analysis.

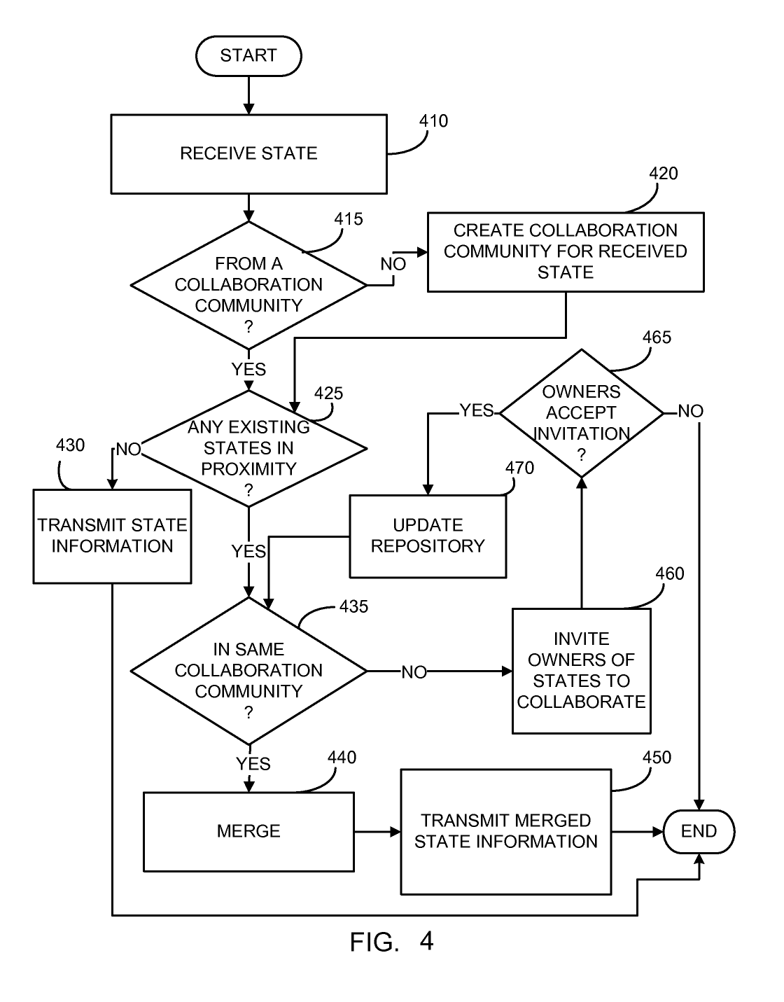

FIG. 4 is a flowchart illustrating the operation of collaboration manager 210, in accordance with an embodiment of the disclosure. In various embodiments, collaboration manager 210 may receive a state to be shared, at 410, from a collaborator's device 124 and may store the received state, along with any state dimensions, in the repository 220. The received state may be the result of an iteration of data exploration that is already associated with a collaboration community 100. If collaboration manager 210 determines, at 415, the received state is not already associated with a collaboration community 100, collaboration manager 210 may create a collaboration community, at 420, for the received state. The created collaboration community 100 may initially include only the member 110 sharing the received state. In various embodiments, collaboration manager 210 may assign member 110 as the owner of the created collaboration community 100. A received state that is already associated with a collaboration community 100 may be associated with a collaboration community 100 that was previously created by collaboration manager 210, at 420, or in certain embodiments, may be associated with a manually created collaboration community 100.

After collaboration manager 210 determines, at 415, the received state is already associated with a collaboration community 100, or after collaboration manager 210 has created a collaboration community 100, at 420, for the received state, collaboration manager 210 may, at 425, determine if there are any shared states in the repository 220 that may be good candidates for collaboration with the received shared state.

If there are no states in the repository 220 identified by collaboration manager 210 to be good candidates for collaboration, as determined at 425, collaboration manager 210 may transmit information for the received state, including the parent state of the shared state, at 430, to any subscribers and end processing for the received state.

If states in the repository 220 are identified by collaboration manager 210 to be good candidates for collaboration, as determined at 425, collaboration manager 210 may utilize the identified candidate state's repository 220 information and the received state's repository 220 information to determine, at 435, if the states are associated with the same collaboration community 100. In various embodiments, collaboration manager 210 may merge the received state's repository 220 information with the identified candidate state's repository 220 information to combine their paths, at 440, for states associated with the same collaboration community 100. In various embodiments, collaborator capabilities may limit the merging of states to only allow the repository 220 information of states of contributing members 110 to be merged. After the states are merged, collaboration manager 210 may transmit, at 450, the merged states' information to the members 110 owning the merged states and to all subscribers of those states. Subscribers may or may not be members 110 in the collaboration community 100 associated with either of the merged states.

For identified candidate states that collaboration manager 210 determines, at 435, are not associated with the same collaboration community 100 as the received state, collaboration manager 210 may, at 460, transmit an indicator, or invitation, to the member 110 sharing the received state and to the member 110 who shared the identified candidate state to collaborate. The invitation may include, but is not limited to, state dimensions that identify the problems being worked on and the owners' expertise. If collaboration manager 210 receives collaboration acceptance responses, or merge confirmation indicators, from the invited members 110, as determined at 465, collaboration manager 210 may update the repository 220 to bring the identified candidate state, and its owning member 110, into the received state's collaboration community 100, at 470. As described above, when new members 110 are added to a collaboration community 100, the new member's 110 collaboration capabilities may be defined in the repository 220.

In certain embodiments, a new collaboration community 100 may be created for the new collaboration. The owners of the received shared state and the identified candidate states would be the initial members 110 of the new collaboration community 100 and the received state and the identified candidate states would be the initial states associated with the new collaboration community 100. In other embodiments, the owner of the received shared state may join the collaboration communities 100 associated with the identified candidate state. In certain other embodiments, the collaboration communities 100 associated with the received shared state and associated with all the identified candidate states may merge into a single collaboration community 100. In the above embodiments, collaboration capabilities may be established for the members 110 of the reconfigured and expanded collaboration communities 100.

In various embodiments the invited owner of the received state and the owner of the identified candidate state may choose to subscribe to each other's shared states rather than collaborate. In those instances, collaboration communities 100 may be left intact and subscriptions established for the received state and the identified candidate states.

After the collaboration communities 100 are established for the newly identified collaborators, the received shared state and the identified candidate states may now be in the same collaboration community 100 and processing may continue at 435 to determine if the affected states are to be merged.

If collaboration manager 210 receives collaboration rejections from the owners of the received shared state or the identified candidate states, as determined at 465, the collaboration communities 100 and the states remain unchanged, collaboration manager 210 may mark the repository 220 to ignore any further collaboration attempts for the identified candidate states and the received state's collaboration community 100, and processing ends for the received state.

FIG. 5 depicts a block diagram of components of a computing device 222 and member devices 124 of the extensible state sharing environment 299 of FIG. 2, in accordance with an embodiment of the disclosure. It should be appreciated that FIG. 5 provides only an illustration of one implementation and does not imply any limitations with regard to the environments in which different embodiments may be implemented. Many modifications to the depicted environment may be made.

Computing device 222 and member devices 124 can include one or more processors 520, one or more computer-readable RAMs 522, one or more computer-readable ROMs 524, one or more computer readable storage medium 530, device drivers 540, read/write drive or interface 532, and network adapter or interface 536, all interconnected over a communications fabric 526. Communications fabric 526 can be implemented with any architecture designed for passing data and/or control information between processors (such as microprocessors, communications and network processors, etc.), system memory, peripheral devices, and any other hardware components within a system.

One or more operating systems 528, collaboration managers 210, repositories for shared states and paths 220, collaboration communities 100, and preserved states 240 are stored on one or more of the computer-readable storage medium 530 for execution by one or more of the processors 520 via one or more of the respective RAMs 522 (which typically include cache memory). In the illustrated embodiment, each of the computer readable storage medium 530 can be a magnetic disk storage device of an internal hard drive, CD-ROM, DVD, memory stick, magnetic tape, magnetic disk, optical disk, a semiconductor storage device such as RAM, ROM, EPROM, flash memory or any other computer readable storage medium that can store a computer program and digital information.

Computing device 222 and member devices 124 can also include a R/W drive or interface 532 to read from and write to one or more portable computer readable storage medium 570. Collaboration manager 210 and repository for shared states and paths 220 on computing device 222 and collaboration communities 100 and preserved states 240 on member devices 124 can be stored on one or more of the portable computer readable storage medium 570, read via the respective R/W drive or interface 532, and loaded into the respective computer readable storage medium 530.

Computing device 222 and member devices 124 can also include a network adapter or interface 536, such as a TCP/IP adapter card or wireless communication adapter (such as a 4G wireless communication adapter using OFDMA technology). Collaboration manager 210 and repository for shared states and paths 220 on computing device 222 and collaboration communities 100 and preserved states 240 on member devices 124 can be downloaded to the computing device from an external computer or external storage device via a network (for example, the Internet, a local area network or other, wide area network or wireless network) and network adapter or interface 536. From the network adapter or interface 536, the programs are loaded into the computer readable storage medium 530. The network may comprise copper wires, optical fibers, wireless transmission, routers, firewalls, switches, gateway computers, and/or edge servers.

Computing device 222 and member devices 124 can also include a display screen 550, a keyboard or keypad 560, and a computer mouse or touchpad 555. Device drivers 540 interface to display screen 550 for imaging, to keyboard or keypad 560, to computer mouse or touchpad 555, and/or to display screen 550 for pressure sensing of alphanumeric character entry and user selections. The device drivers 540, R/W drive or interface 532, and network adapter or interface 536 can comprise hardware and software (stored in computer readable storage medium 530 and/or ROM 524).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although preferred embodiments have been depicted and described in detail herein, it will be apparent to those skilled in the relevant art that various modifications, additions, substitutions and the like can be made without departing from the spirit of the invention, and these are, therefore, considered to be within the scope of the invention, as defined in the following claims.

What is claimed is:

1. A method for collaboration using extensible state sharing, each state including information dimensions, a subsequent state based on one or more previous states and being associated to the one or more previous states by a path, the method comprising:
receiving, by a computer, a state;
determining, by the computer, if a stored state is within a proximity threshold of the received state based on the information dimensions of the stored and received states; and
responsive to determining a stored state is within a proximity threshold of the received state, merging, by the computer, the stored state and the received state.

2. The method according to claim 1, wherein each state is associated with a collaboration community, one or more subscribers are associated with each collaboration community, and the information dimensions of each state includes a collaboration community identifier, and
wherein responsive to determining further comprises:
responsive to determining a stored state is within a proximity threshold of the received state, determining, by the computer, if the collaboration community identifier associated with the stored state is equal to the collaboration community identifier associated with the received state;
responsive to determining the collaboration community identifier associated with the stored state is equal to the collaboration community identifier associated with the received state:
merging, by the computer, the stored state and the received state; and
transmitting to the subscriber, by the computer, the merged state; and
responsive to determining the collaboration community identifier associated with the stored state is not equal to the collaboration community identifier associated with the received state:
transmitting to the subscriber, by the computer, an indicator that the stored state is within the proximity threshold of the received state.

3. The method according to claim 2, wherein transmitting to the subscriber, by the computer, an indicator that the stored state is within the proximity threshold of the received state further comprises:
responsive to receiving a merge confirmation indicator from the subscriber:
merging, by the computer, the stored state and the received state; and
transmitting to the subscriber, by the computer, the merged state.

4. The method according to claim 1, wherein the information dimensions include one or more of:
a group identifier;
a state identifier;
a parent state identifier;
a sender identifier;
a path;
an owner;
a problem description;
a source of data;
a user added tag;
a proximity algorithm; and
a proximity threshold.

5. The method according to claim 1, wherein the proximity threshold is a value that includes one or more of:
a default value;
a configured value; and
a value included in the information dimensions of a state.

6. The method according to claim 1, wherein merging, by the computer, the stored state and the received state further comprises:
adding the path of the received state to the path of the stored state; and
adding the path of the stored state to the path of the received state.

7. A computer program product for collaboration using extensible state sharing, each state including information dimensions, a subsequent state based on one or more previous states and being associated to the one or more previous states by a path, the computer program product comprising one or more computer readable storage medium and program instructions stored on at least one of the one or more computer readable storage medium, the program instructions comprising:
program instructions to receive, by a computer, a state;
program instructions to determine, by the computer, if a stored state is within a proximity threshold of the received state based on the information dimensions of the stored and received states; and
responsive to program instructions determining a stored state is within a proximity threshold of the received state, program instructions to merge, by the computer, the stored state and the received state.

8. The computer program product according to claim 7, wherein each state is associated with a collaboration community, one or more subscribers are associated with each collaboration community, and the information dimensions of each state includes a collaboration community identifier, and
wherein responsive to program instructions determining further comprises:
responsive to program instructions determining a stored state is within a proximity threshold of the received state, program instructions to determine, by the computer, if the collaboration community identifier associated with the stored state is equal to the collaboration community identifier associated with the received state;
responsive to program instructions determining the collaboration community identifier associated with the stored state is equal to the collaboration community identifier associated with the received state:
program instructions to merge, by the computer, the stored state and the received state; and
program instructions to transmit to the subscriber, by the computer, the merged state; and
responsive to program instructions determining the collaboration community identifier associated with the stored state is not equal to the collaboration community identifier associated with the received state:
program instructions to transmit to the subscriber, by the computer, an indicator that the stored state is within the proximity threshold of the received state.

9. The computer program product according to claim 8, wherein program instructions to transmit to the subscriber, by the computer, an indicator that the stored state is within the proximity threshold of the received state further comprises:
responsive to program instructions receiving a merge confirmation indicator from the subscriber:
program instructions to merge, by the computer, the stored state and the received state; and
program instructions to transmit to the subscriber, by the computer, the merged state.

10. The computer program product according to claim 7, wherein the information dimensions include one or more of:
a group identifier;
a state identifier;
a parent state identifier;
a sender identifier;
a path;
an owner;
a problem description;
a source of data;
a user added tag;
a proximity algorithm; and
a proximity threshold.

11. The computer program product according to claim 7, wherein the proximity threshold is a value that includes one or more of:
a default value;
a configured value; and
a value included in the information dimensions of a state.

12. The computer program product according to claim 7, wherein program instructions to merge, by the computer, the stored state and the received state further comprises:
program instructions to add the path of the received state to the path of the stored state; and
program instructions to add the path of the stored state to the path of the received state.

13. A computer system for collaboration using extensible state sharing, each state including information dimensions, a subsequent state based on one or more previous states and being associated to the one or more previous states by a path, the computer system comprising one or more processors, one or more computer readable memories, one or more computer readable tangible storage medium, and program instructions stored on at least one of the one or more storage medium for execution by at least one of the one or more processors via at least one of the one or more memories, the program instructions comprising:
program instructions to receive, by a computer, a state;
program instructions to determine, by the computer, if a stored state is within a proximity threshold of the received state based on the information dimensions of the stored and received states; and
responsive to program instructions determining a stored state is within a proximity threshold of the received state, program instructions to merge, by the computer, the stored state and the received state.

14. The computer system according to claim 13, wherein each state is associated with a collaboration community, one or more subscribers are associated with each collaboration community, and the information dimensions of each state includes a collaboration community identifier, and
wherein responsive to program instructions determining further comprises:
responsive to program instructions determining a stored state is within a proximity threshold of the received state, program instructions to determine, by the computer, if the collaboration community identifier associated with the stored state is equal to the collaboration community identifier associated with the received state;
responsive to program instructions determining the collaboration community identifier associated with the stored state is equal to the collaboration community identifier associated with the received state:
program instructions to merge, by the computer, the stored state and the received state; and
program instructions to transmit to the subscriber, by the computer, the merged state; and
responsive to program instructions determining the collaboration community identifier associated with the stored state is not equal to the collaboration community identifier associated with the received state:
program instructions to transmit to the subscriber, by the computer, an indicator that the stored state is within the proximity threshold of the received state.

15. The computer system according to claim 14, wherein program instructions to transmit to the subscriber, by the computer, an indicator that the stored state is within the proximity threshold of the received state further comprises:
responsive to program instructions receiving a merge confirmation indicator from the subscriber:
program instructions to merge, by the computer, the stored state and the received state; and
program instructions to transmit to the subscriber, by the computer, the merged state.

16. The computer system according to claim 13, wherein the information dimensions include one or more of:
a group identifier;
a state identifier;
a parent state identifier;
a sender identifier;
a path;
an owner;
a problem description;
a source of data;
a user added tag;
a proximity algorithm; and
a proximity threshold.

17. The computer system according to claim 13, wherein the proximity threshold is a value that includes one or more of:
a default value;
a configured value; and
a value included in the information dimensions of a state.

18. The computer system according to claim 13, wherein program instructions to merge, by the computer, the stored state and the received state further comprises:
program instructions to add the path of the received state to the path of the stored state; and
program instructions to add the path of the stored state to the path of the received state.
